(19) United States
(12) Patent Application Publication
(10) Pub. No.: US 2023/0313473 A1
(43) Pub. Date: Oct. 5, 2023

(54) NAVIGATION MARKERS FOR AUTONOMOUS ROBOTIC VEHICLES AND MARKER PLACEMENT TOOLS

(71) Applicant: Rocky Mountain Robotech LLC, Superior, CO (US)

(72) Inventors: Chunbiao GU, Superior, CO (US); Shichao ZHANG, Superior, CO (US)

(21) Appl. No.: 17/710,286

(22) Filed: Mar. 31, 2022

(51) Int. Cl. E01F 9/30; B25J 1/02

(52) U.S. Cl. CPC E01F 9/30; B25J 1/02; G05D 1/0234

(57) ABSTRACT

Navigation markers for use by autonomous robotic vehicles comprise a plate having a flat front surface, one or more position markers made of a reflective material, an infrared material, or a combination thereof disposed on the flat front surface, and a pair of first mechanical arms extending from the plate and articulable relative to the plate. The articulable mechanical legs allow the plate to be mounted to flat or curved surfaces, such as ductwork. Further, the plate can be prepared with numerous navigation markers prior to placement on the ceiling, and a special placement tool allows the plate to be attached to the ceiling from a distance, such that ladders, lifts, stilts, and the like may not be necessary, thereby improving safety and installation efficiency.

### CROSS-REFERENCE TO RELATED APPLICATIONS

None.

### STATEMENT REGARDING FEDERALLY SPONSORED RESEARCH

None.

### BACKGROUND

Autonomous robotic vehicles (ARVs) are vehicles capable of navigating routes through the use of onboard sensors that detect exogenous navigation markers or other objects within the surroundings. For example, an ARV may contain one or more infrared, near field, or radio sensors, cameras, or other detection devices that capture data from navigation markers or other surroundings. The data or images are then analyzed by a local or remote computer processor to determine what action the ARV should perform (e.g., stop, turn, reverse, etc.), and the processor sends instructions for carrying out the action to motive components of the ARV. The motive components then perform the action—all without human supervision.

Existing ARV systems typically navigate from individually placed markers, which are generally placed on flat portions of a structure's ceiling. However, placement of markers individually requires numerous locations to be identified and equipment and people to be continually moved during the set-up process. Thus, a person might spend hours ascending and descending a ladder to place markers on the ceiling. This is inefficient, and creates numerous opportunities for personal injuries and structural damage. In addition, visual markers can be unsightly and impractical for non-flat ceilings. This is especially problematic in commercial spaces where exposed ductwork and/or structural bracing may be present. For at least these reasons, ARV navigation systems and methods are imperfect.

### SUMMARY

The present devices, tools, and methods utilize navigation markers on a flat plate joined to a plurality of articulable mechanical legs that allow the plate to be mounted to flat or curved surfaces, such as ductwork. Further, the plate can be prepared with numerous navigation markers prior to placement on the ceiling, and a special tool described herein allows the plate to be placed on the ceiling from a distance, such that ladders, lifts, stilts, and the like may not be necessary. Use of the placement tool improves safety and installation efficiency, which ultimately saves money.

In an aspect, a navigation marker for use by an autonomous robotic vehicle comprises a plate having a flat front surface, one or more position markers made of a reflective material, an infrared material, or a combination thereof disposed on the flat front surface, and a pair of first mechanical arms extending from the plate and articulable relative to the plate. The flat front surface of the plate may be of any shape, such as but not limited to circular, oval, rectilinear, triangular, hexagonal, octagonal, or irregular. In an embodiment, the position markers are made of reflective material, such as reflective paint that is clear when dry.

In an embodiment, the mechanical arms of a navigation marker articulate in a direction perpendicular to a plane of the flat front surface. In some embodiments, the mechanical arms are independently articulable. In other embodiment, the mechanical arms are jointly articulable.

In an embodiment, a navigation marker is adhered to a ceiling structure via double-sided adhesive applied to a back surface of the plate. In an embodiment, a navigation marker is magnetically adhered to a ceiling structure. For example, each of the mechanical arms may comprise a magnet at its distal end, or at least one of the mechanical arms comprises a magnet at its distal end, and/or a magnet is disposed on a back surface of the plate.

In an embodiment, the pair of mechanical arms extends from a back surface of the plate. In an embodiment, the pair of mechanical arms extends from edges or corners of the plate.

In an embodiment, a navigation marker further comprises at least one additional mechanical arm. In an embodiment, the at least one additional mechanical arm is physically joined to one of the first mechanical arms. For example, when there are four mechanical arms, they may extend from a central point at 0, 90, 180 and 270 degrees.

In an embodiment, the reflective material of a position marker is translucent, clear and/or transparent.

In an aspect, a placement tool comprises a pole, a support platform at a distal end of the pole, a plurality of arms surrounding the support platform, one or more of which is a spring-loaded arm, and a trigger line attached to the spring-loaded arm and extending toward a proximal end of the pole. Each of the plurality of arms has a notch facing the support platform, which is used to engage and temporarily secure an object on the support platform. The spring-loaded arm is pivotally mounted to the pole, rotatable around an axis perpendicular to a longitudinal axis of the pole, and joined to the pole by a spring. For example, the spring may be a coil spring or an elastic band.

In an embodiment, the pole is a telescoping pole.

In an embodiment, each of the plurality of arms has one or more additional notches facing the support platform. This allows the arms to accommodate different sized objects.

In an embodiment, the plurality of arms comprises three or more arms, four or more arms, six or more arms, eight or more arms, or a number of arms equal to a number of sides of the object to be placed by the placement tool.

In an embodiment, a placement tool further comprises a bracket for securing the plurality of arms to the pole.

In an embodiment, angles between interior edges of the plurality of arms and the pole are adjustable. For example, the angles may be individually adjustable or jointly adjustable.

In an aspect, a system for efficient deployment of navigation markers that guide an autonomous robotic vehicle comprises a placement tool and one or more navigation markers, both of which are described herein.

In as aspect, a method of using a placement tool to place a navigation marker on the ceiling of a structure comprises temporarily clamping a plate of a navigation marker on a support platform of the placement tool such that the back surface of the plate faces away from the support platform and edges of the plate are disposed within notches of a plurality of arms; pushing the placement tool and navigation marker upward to cause the back surface of the plate (e.g., an adhesive on the back surface of the plate or magnets on or within mechanical arms of the plate) to connect with a portion of a structure's ceiling; pulling a trigger line to release at least one of the plurality of arms that is spring-loaded; and, while the spring-loaded arm is released, moving the placement tool laterally to free edges of the plate from notches of the still-engaged arms.

### BRIEF DESCRIPTION OF THE DRAWINGS

Illustrative embodiments of the present invention are described in detail below with reference to the attached drawings, wherein:

FIG. 1 is a schematic showing a back perspective view of a navigation marker having a circular plate, according to an embodiment;

FIG. 2 is a back plan view of the navigation marker of FIG. 1;

FIG. 3 is a back perspective view of a navigation marker having a rectilinear plate, according to an embodiment;

FIG. 4 is a side plan view of a navigation marker magnetically attached to a curved surface, according to an embodiment;

FIG. 5 is a side plan view of a navigation marker adhesively attached to a curved surface, according to an embodiment;

FIG. 6 is a schematic of a distal end of a placement tool for attaching objects to elevated surfaces, according to an embodiment;

FIG. 7 is a schematic of the distal end of the placement tool of FIG. 6 holding a navigation marker, according to an embodiment;

FIG. 8 shows the articulable mechanical arms of the navigation marker of FIG. 7 articulating away from a flat front surface of the marker, according to an embodiment;

FIG. 9 shows a navigation marker being placed on a ceiling beam structure, where a spring-loaded mechanical arm of the placement tool has been actuated to release the navigation marker from the placement tool, according to an embodiment; and

FIG. 10 shows steps for coordinating the delivery of goods by an autonomous robotic vehicle using a plurality of the navigation markers disclosed herein, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

“Proximal” and “distal” refer to the relative positions of two or more objects, planes or surfaces. For example, an object that is close in space to a reference point relative to the position of another object is considered proximal to the reference point, whereas an object that is further away in space from a reference point relative to the position of another object is considered distal to the reference point.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third object).

As used herein, the terms “processor” and “computer” and related terms, e.g., “processing device”, “computing device”, and “controller” are not limited to just those integrated circuits referred to in the art as a computer, but broadly refer to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Exemplary navigation markers and placement tools can be seen in FIGS. 1-9. Multiple items within a figure may not be labeled for clarity.

FIG. 1 shows a back perspective view of a navigation marker 100 for use by an ARV. Navigation marker 100 includes a circular plate 102, one or more position markers 104 on a flat front surface of the plate, and a pair of mechanical arms 106 extending from the plate and articulable relative to the plate. Each mechanical arm 106 may include a magnet 108 at its distal end for use in attaching the navigation marker to a magnetic surface. In some embodiments, the plate is made of metal, plastic, carbon fiber, cardboard, or combinations thereof. In an embodiment, the plate is made of colorless transparent plastic to limit the aesthetic impact of the navigation marker.

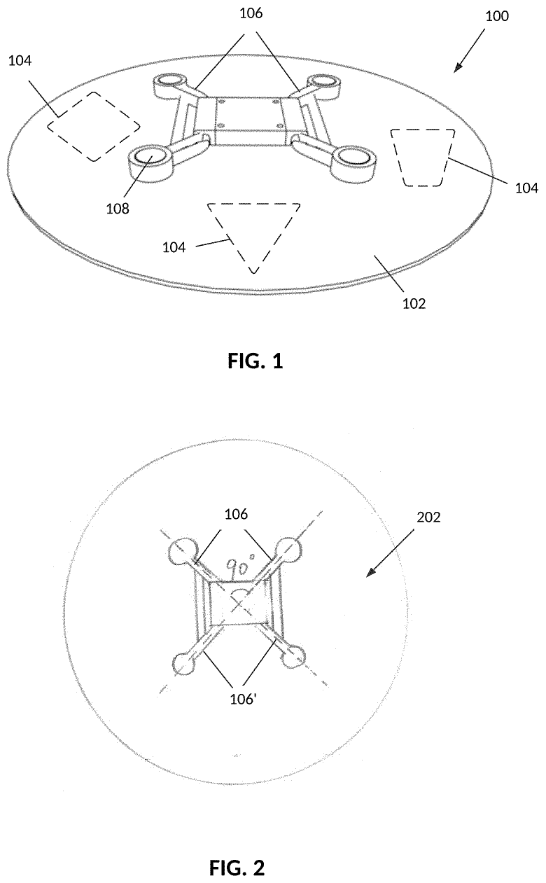

FIG. 2 is a back plan view of navigation marker 100, where the pair of mechanical arms 106 and a pair of additional arms 106′ extend from a back surface 202 of plate 102 at right angles relative to one another.

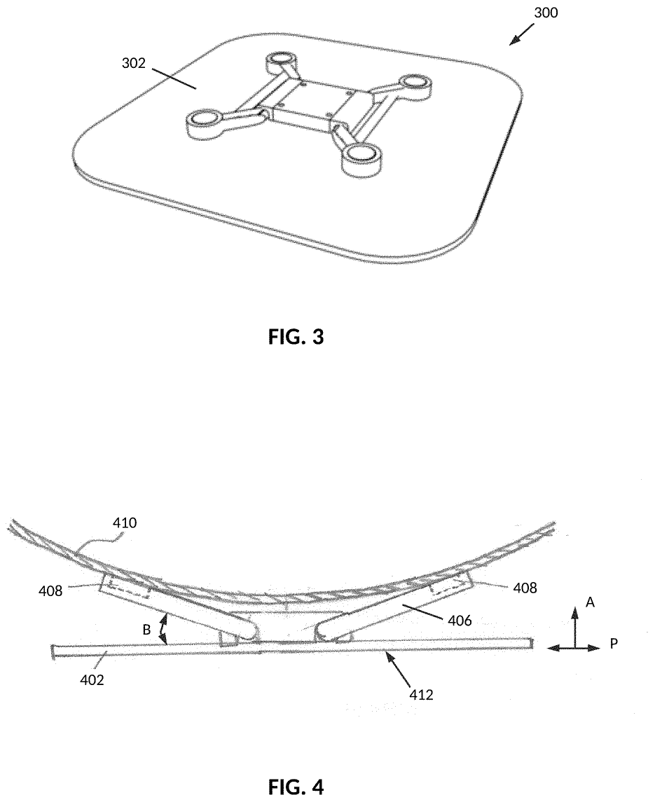

FIG. 3 is a back perspective view of a navigation marker 300 having a rectilinearly shaped plate 302.

FIG. 4 is a side plan view of a navigation marker magnetically attached to a curved surface 410 by magnets 408 embedded within articulable mechanical arms 406 that articulate in a direction (A) perpendicular to a plane (P) of the flat front surface 412 of plate 402. In an embodiment, mechanical arms 406 are independently articulable.

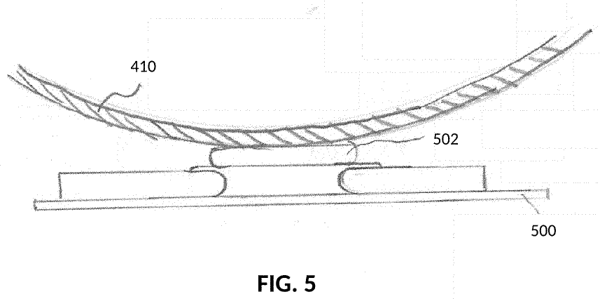

FIG. 5 is a side plan view of a navigation marker 500 adhesively attached to a curved surface 410 using a double-sided adhesive 502.

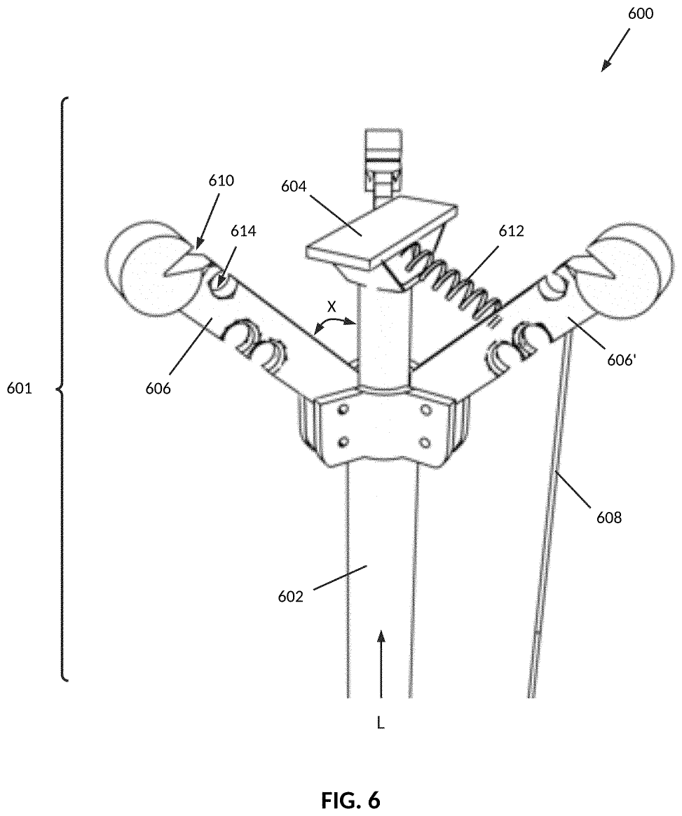

FIG. 6 is a schematic of a distal end 601 of a placement tool 600 for attaching objects, such as but not limited to navigation markers as disclosed herein, to elevated surfaces. Placement tool 600 includes a pole 602 having a support platform 604, a plurality of arms 606 surrounding support platform 604 and a trigger line 608. Each of the plurality of arms 606 has a notch 610 facing support platform 604, and at least one of the arms is a spring-loaded arm 606′ pivotally mounted to pole 602, rotatable around an axis perpendicular to a longitudinal axis (L) of pole 602, and joined to pole 602 by a spring 612, which may be a coil spring or an elastic band. In some embodiments, each of the plurality of arms 606 has one or more additional notches 614 facing support platform 604, which can be used to accommodate objects of various sizes. In some embodiments, angles (X) between interior edges of the arms 606 and pole 602 are individually adjustable or jointly adjustable.

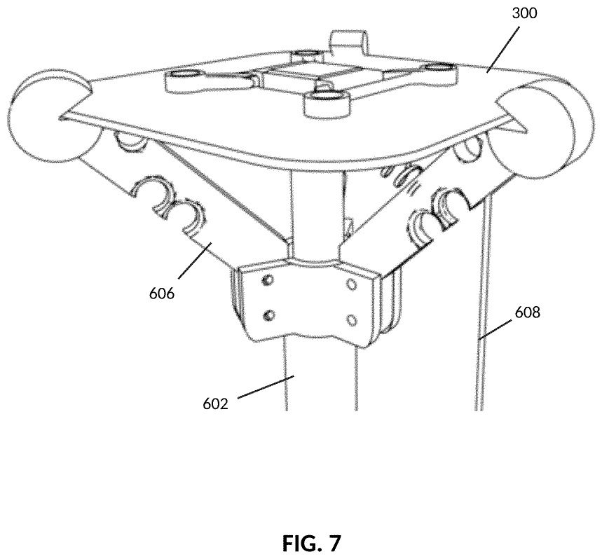

FIG. 7 is a schematic of the distal end 601 of placement tool 600 holding a navigation marker 300 on support platform 604 and within notches 610 of each arm 606.

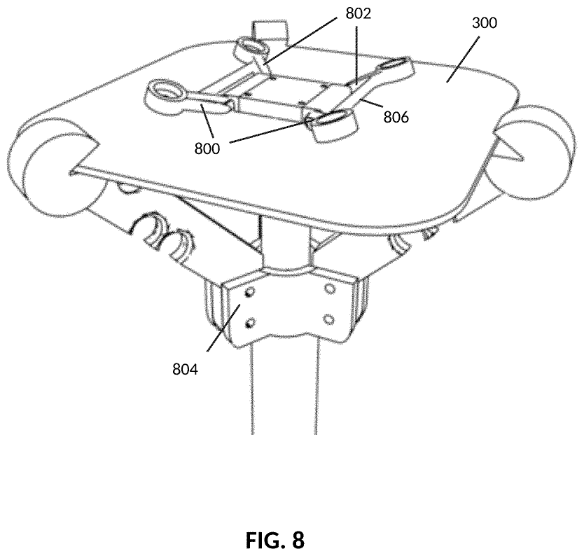

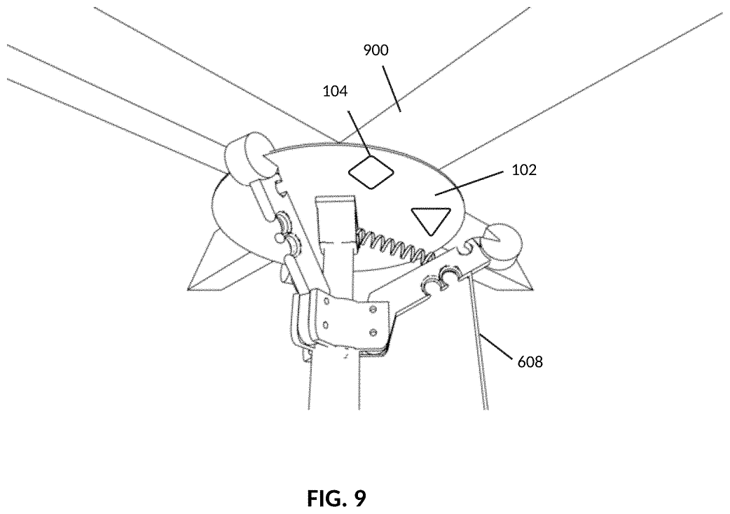

FIG. 8 shows the articulable mechanical arms 800 of navigation marker 300 articulating away from a flat front surface of the marker. In addition, the marker contains a pair of additional mechanical arms 802. The additional mechanical arms 802 may be physically joined to mechanical arms 800 through one or more connectors 806. In some embodiments, a bracket 804 joins arms 606 to pole 602.

FIG. 9 shows a navigation marker 102 being placed on a ceiling beam 900, where a spring-loaded mechanical arm 606′ of the placement tool 600 has been actuated by trigger line 608 to release a portion of navigation marker 102 from the placement tool. Marker 102 may be further released by moving the distal end 601 of placement tool 600 laterally.

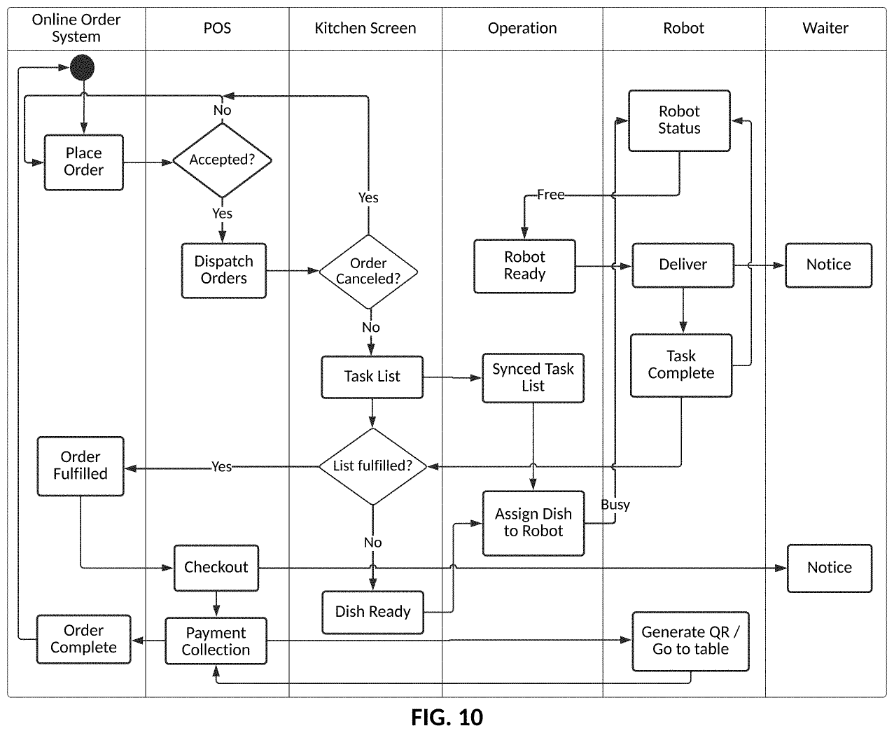

FIG. 10 shows steps for coordinating the delivery of goods, in this case food in a restaurant setting, by an autonomous robotic vehicle using a plurality of the navigation markers disclosed herein, according to an embodiment. The process flow shown in FIG. 10 is divided into an online order system, a point of sale (POS), a kitchen screen, an operation system, a robot (ARV), and a human waiter. The process begins at the circle in the top left corner with an order being placed. A query determines whether the order can be accepted (e.g., is correctly completed). If the answer is “no”, the process reverts to the order placement step. If the answer is “yes”, the order is dispatched through another query asking whether the order has been canceled. If the order has not been canceled, it is assigned to a task list in the kitchen. If the order has been canceled, the process reverts to the order placement step. Once the order is assigned to the kitchen task list, it is also entered into a synchronized task list in the operating system or control unit. The task list is constantly querying the status of orders/dishes in the task list. Once a dish is ready for delivery, it is assigned to a robot, which then reports its status as busy or has its status set to busy as part of the assignment process. The assigned robot retrieves the dish from the kitchen and delivers the dish to the customer using navigation markers of the type disclosed herein. Completion of the delivery task means that the task is complete, the robot status is changed to “free”, a waiter is notified, and the order status is changed to “fulfilled” in the online order system. Changing the order status to “fulfilled” initiates a checkout procedure with payment collection at the point of sale either by a human waiter that is notified of the checkout or by a robot, e.g., via a QR code linked to a currency transfer application. After payment collection, the order status in the online order system is set to “order complete”.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a magnet” includes a plurality of such notches and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements or limitation or limitations which is/are not specifically disclosed herein.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

What is claimed is:

1. A navigation marker for use by an autonomous robotic vehicle comprising:
a plate having a flat front surface;
one or more position markers made of a reflective material, an infrared material, or a combination thereof disposed on the flat front surface; and
a pair of first mechanical arms extending from the plate and articulable relative to the plate.

2. The navigation marker of claim 1, wherein the first mechanical arms articulate in a direction perpendicular to a plane of the flat front surface.

3. The navigation marker of claim 1, wherein the first mechanical arms are independently articulable.

4. The navigation marker of claim 1, wherein each of the first mechanical arms comprises a magnet at its distal end.

5. The navigation marker of claim 1, wherein the pair of first mechanical arms extends from a back surface of the plate.

6. The navigation marker of claim 1 further comprising at least one additional mechanical arm.

7. The navigation marker of claim 6, wherein the at least one additional mechanical arm is physically joined to one of the first mechanical arms.

8. The navigation marker of claim 1, wherein the reflective material is translucent.

9. A placement tool comprising:
a pole;
a support platform at a distal end of the pole;
a plurality of arms surrounding the support platform, each of the plurality of arms having a notch facing the support platform;
wherein one or more of the plurality of arms is a spring-loaded arm pivotally mounted to the pole, rotatable around an axis perpendicular to a longitudinal axis of the pole, and joined to the pole by a spring; and
a trigger line attached to the spring-loaded arm and extending toward a proximal end of the pole.

10. The placement tool of claim 9, wherein the pole is a telescoping pole.

11. The placement tool of claim 9, wherein the spring is a coil spring or an elastic band.

12. The placement tool of claim 9, wherein each of the plurality of arms has one or more additional notches facing the support platform.

13. The placement tool of claim 9, wherein angles between interior edges of the plurality of arms and the pole are adjustable.

14. The placement tool of claim 13, wherein the angles are individually adjustable or jointly adjustable.

15. A navigation marker and placement tool system comprising:
a navigation marker comprising:
a plate having a flat front surface;
one or more position markers made of a reflective material, an infrared material, or a combination thereof disposed on the flat front surface; and
a pair of first mechanical arms extending from the plate and articulable relative to the plate;
a placement tool for the navigation marker, the placement tool comprising:
a pole;
a support platform for the plate at a distal end of the pole;
a plurality of arms surrounding the support platform, each of the plurality of arms having a notch facing the support platform to interact with edges of the plate;
wherein one or more of the plurality of arms is a spring-loaded arm pivotally mounted to the pole, rotatable around an axis perpendicular to a longitudinal axis of the pole, and joined to the pole by a spring; and
a trigger line attached to the spring-loaded arm and extending toward a proximal end of the pole such that pulling the trigger line toward the proximal end opens the spring-loaded arm and allows the plate to separate from the placement tool.

16. The system of claim 15, wherein the first mechanical arms articulate in a direction perpendicular to a plane of the flat front surface.

17. The system of claim 15, wherein the first mechanical arms are independently articulable.

18. The system of claim 15, wherein the pair of first mechanical arms extends from a back surface of the plate.

19. The system of claim 15 further comprising at least one additional mechanical arm.

20. The system of claim 19, wherein the at least one additional mechanical arm is physically joined to one of the first mechanical arms.
